(19) United States
(12) Patent Application Publication
(10) Pub. No.: US 2015/0002743 A1
(43) Pub. Date: Jan. 1, 2015

(54) VIDEO DATA DISPLAYING SYSTEM AND VIDEO DATA DISPLAYING METHOD

(71) Applicant: MediaTek Inc., Hsin-Chu (TW)

(72) Inventor: Hao-Jung Li, Hsinchu County (TW)

(73) Assignee: MediaTek Inc., Hsin-Chu (TW)

(21) Appl. No.: 14/153,061

(22) Filed: Jan. 12, 2014

Related U.S. Application Data
(60) Provisional application No. 61/841,494, filed on Jul. 1, 2013.

(51) Int. Cl. H04N 5/44; H04W 88/02; H04N 5/445

(52) U.S. Cl. CPC H04N 5/4403; H04N 5/44582; H04W 88/02
USPC 348/563

(57) ABSTRACT

A video data displaying system comprising a first electronic device and a second electronic device. The first electronic device comprises: a data receiver, for receiving video data; a first displaying device, for displaying the video data; and a connecting interface. The second electronic device receives relative information related with the video data and transmitting the relative information to the first electronic device if the second electronic device is connected to the first electronic device via the connecting interface. The first displaying device displays the relative information while displaying the video data. In one embodiment, the second electronic comprises a second displaying device smaller than the first displaying device.

### CROSS REFERENCE TO RELATED APPLICATIONS

This application claims the benefit of U.S. Provisional Application No. 61/841,494, filed on Jul. 1, 2013, the contents of which are incorporated herein by reference.

### BACKGROUND

The smart phone becomes very popular for recent years. A smart phone can provide many other functions such as displaying video data or browsing a website besides making/receiving a phone call. FIG. 1 is a schematic diagram illustrating a related art mobile phone displaying video data and advertisement. As shown in FIG. 1, the mobile phone 100 comprises a displaying device 101, which can display video data.

However, utilizing the mobile phone to display video data may cause following disadvantages: the size for the displaying device is too small and the input interface (ex. a touch screen or a keypad) for the mobile phone is too small to provide a control command. Some techniques are developed to solve this problem. For example, the mobile phone can be synchronized with a laptop, such that the laptop can show content of the mobile phone and a user can use the input interface for the laptop to control the mobile phone. However, such laptop needs many devices provide therein. For example, a CPU and a drawing chip, thus a user must spend a lot of money to buy a laptop which is seldom used.

Additionally, if the video data is from a network, the displaying device 101 may also displays the advertisement AD while displaying the video data. However, the advertisement AD may be non-relative with the advertisement, such that the user who is watching the video data may feel confused or disturbed.

Therefore, a new video data displaying system and a new video data displaying method are needed.

### SUMMARY

Therefore, one objective of the present application is to provide a video data displaying system and a video displaying method that can display information related with the video data.

One embodiment of the present application discloses a video data displaying system comprising a first electronic device and a second electronic device. The first electronic device comprises: a data receiver, for receiving video data; a first displaying device, for displaying the video data; and a connecting interface. The second electronic device receives relative information related with the video data and transmitting the relative information to the first electronic device if the second electronic device is connected to the first electronic device via the connecting interface. The first displaying device displays the relative information while displaying the video data. In one embodiment, the second electronic comprises a second displaying device smaller than the first displaying device.

Another embodiment of the present application discloses a video data displaying method applied to a video data displaying system comprising a first electronic device and a second electronic device. The first electronic device comprises a first displaying device, a data receiver and a connecting interface. The video data displaying method comprises: receiving video data via the data receiver; receiving relative information related with the video data via the second electronic device; transmitting the relative information to the first electronic device if the second electronic device is connected to the first electronic device via the connecting interface; and displaying the relative information while displaying the video data via the first displaying device.

In view of above-mentioned embodiments, the present application can provide following advantage: video data can be displayed on a larger displaying device; the information displayed with the video data is relative with the video data such that the user can get information about the video data or trigger process about the video data; the electronic device for displaying the video data can comprise fewer or less powerful devices such that the weight and the cost thereof can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a related art mobile phone displaying video data and advertisement.

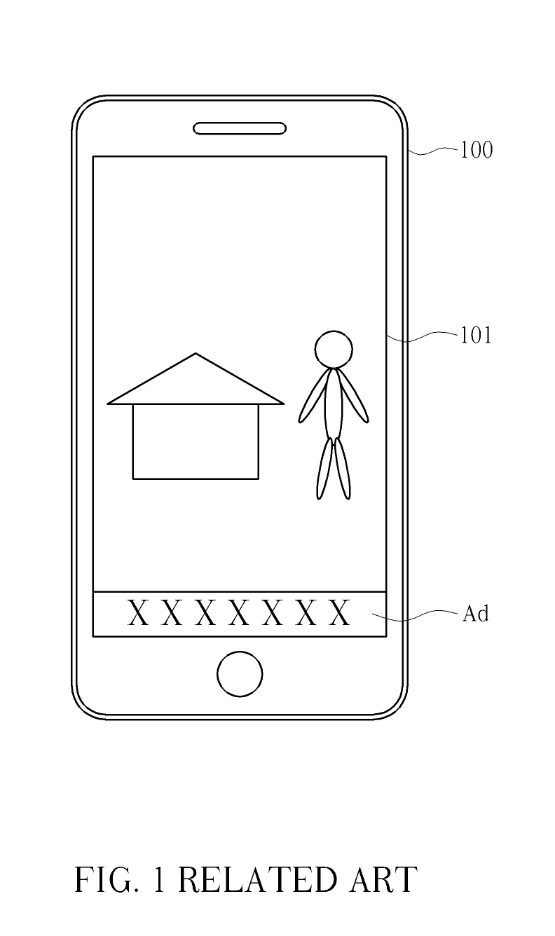

FIG. 2 is a schematic diagram illustrating a video data displaying system according to an embodiment of the present application.

FIG. 3 is a schematic diagram illustrating the operation for displaying video data and relative information related with the video data according to one embodiment of the present application.

FIG. 4 is a schematic diagram illustrating the mobile phone display different scenes for the mobile phone connected to the laptop and the mobile phone not connected to the laptop.

FIG. 5 is a block diagram illustrating the blocks for the mobile phone and the laptop according to one embodiment of the present application.

FIG. 6 is a block diagram illustrating the blocks for the mobile phone and the laptop according to another embodiment of the present application.

FIG. 7 is a flow chart illustrating a video data displaying method according to one embodiment of the present application.

### DETAILED DESCRIPTION

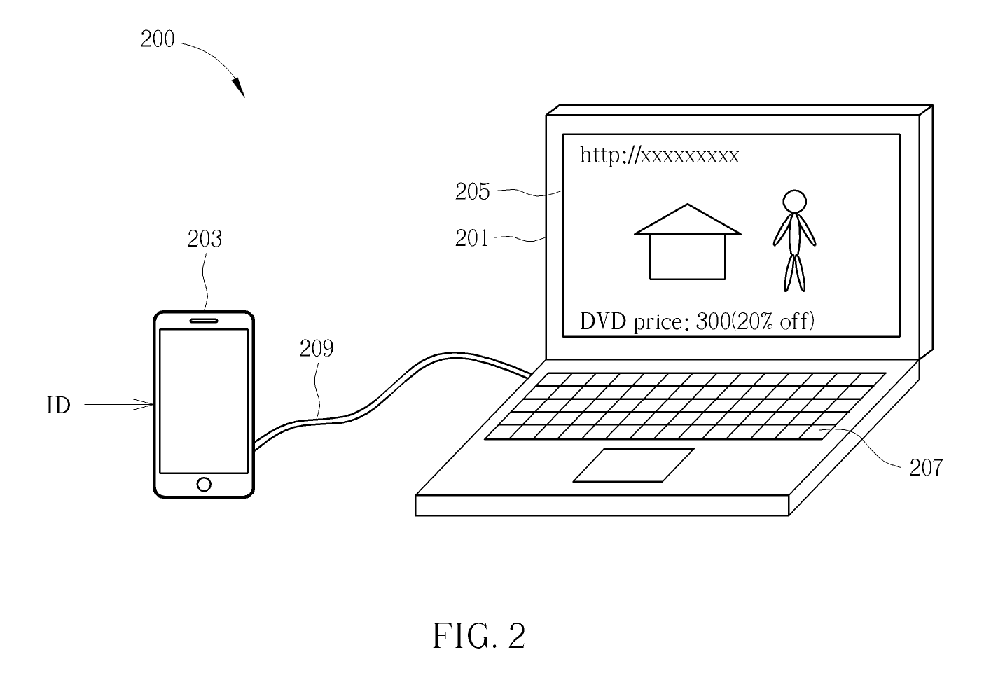

FIG. 2 is a schematic diagram illustrating a video data displaying system according to an embodiment of the present application. Please note a mobile phone and a lap top are applied as an example for the following embodiments, but do not mean to limit the scope of the present application. Other devices can be applied for the present application as well. For example, the mobile phone can be replaced with a table PC, and the lap top can be replaced with a monitor without a user input interface.

As shown in FIG. 2, the video displaying system 200 comprises a laptop 201 and a mobile phone 203. The laptop 201 comprises a displaying device 205 for displaying video data. The mobile phone 203 receives relative information ID via a network (but not limited to a network) related with the video data and transmits the relative information ID to the laptop 201 when the mobile phone 203 is connected to the laptop 201. The displaying device 205 also displays the relative information ID while displaying the video data. The above-mentioned video data can be from any source. For example, either a TV data source, a network, or a storage device can be the source for the video data. Additionally, in one embodiment, at least one particular index indicating which relative information ID should be provided is embedded to the video data, and the mobile phone 203 can receive relative information ID based on the particular index. Furthermore, the mobile phone 203 is not limited to be connected to the laptop 201. Other connecting mechanisms (wired or wireless) can also be applied to connect the mobile phone 203 to connect the laptop 201.

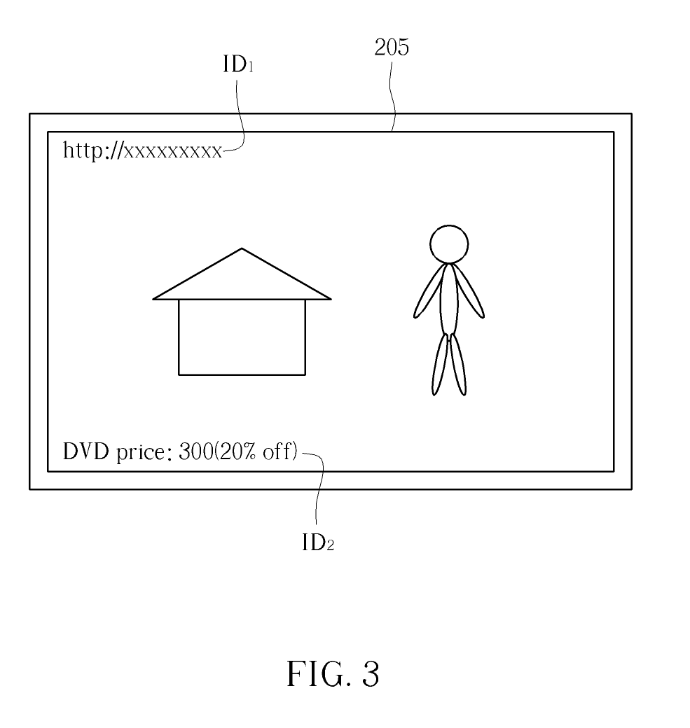

FIG. 3 is a schematic diagram illustrating the operation for displaying video data and relative information related with the video data according to one embodiment of the present application. As shown in FIG. 3, the displaying device 205 displays the video data, the relative information ID₁, and the relative information ID₂. In this embodiment, the relative information ID₁ is a link related with the video data. For example, if the video data is a movie preview, the relative information ID₁ is a link for a website introducing the movie and provides showing timing and locations for the movie. Or, if the video data is from a game advertisement, the relative information ID₁ is a link for a website introducing the game. Additionally, the relative information ID₂ is a command. If a user activates the command, a purchasing process can be activated, such that the user can directly buy relative products such as a DVD or a poster related with the video data. The laptop 201 can further comprise an input interface 207 (ex. a keyboard) for receiving a control command from a user. By this way, the user can activate the link or the command via the input interface 207. However, the relative information is not limited to above-mentioned link or command.

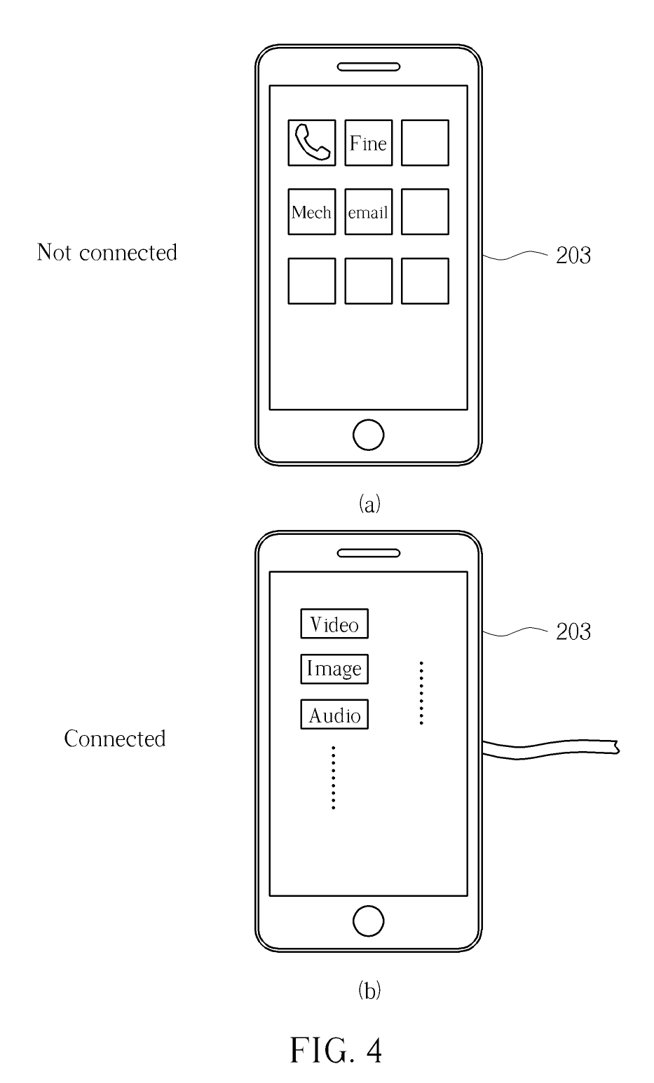

In one embodiment, the mobile phone displays a first scene if the mobile phone is not connected to the laptop. However, the mobile phone displays a second scene if the mobile phone is connected to the laptop. The control command via the input interface (ex. 207 in FIG. 2) changes data corresponding to the second scene but does not change data corresponding to the first scene. FIG. 4 is a schematic diagram illustrating the mobile phone display different scenes for the mobile phone connected to the laptop and the mobile phone not connected to the laptop. FIG. 4 comprises two sub diagrams FIG. 4(a) and FIG. 4(b). FIG. 4(a) illustrates a state that the mobile phone 203 is not connected to the laptop 201 and FIG. 4(b) illustrates a state that the mobile phone 203 is connected to the laptop 201. As shown in FIG. 4(a), the mobile phone 203 displays a first scene, which is a user interface comprising a plurality of icons in this embodiment. If the mobile phone 203 is connected to the laptop 201, as shown in FIG. 4(b), the mobile phone 203 displays a second scene, which comprises a plurality of data folders. The user can change the data in the folder via the control command. The action for varying the data corresponding to the second scene does not change the data corresponding to the first scene.

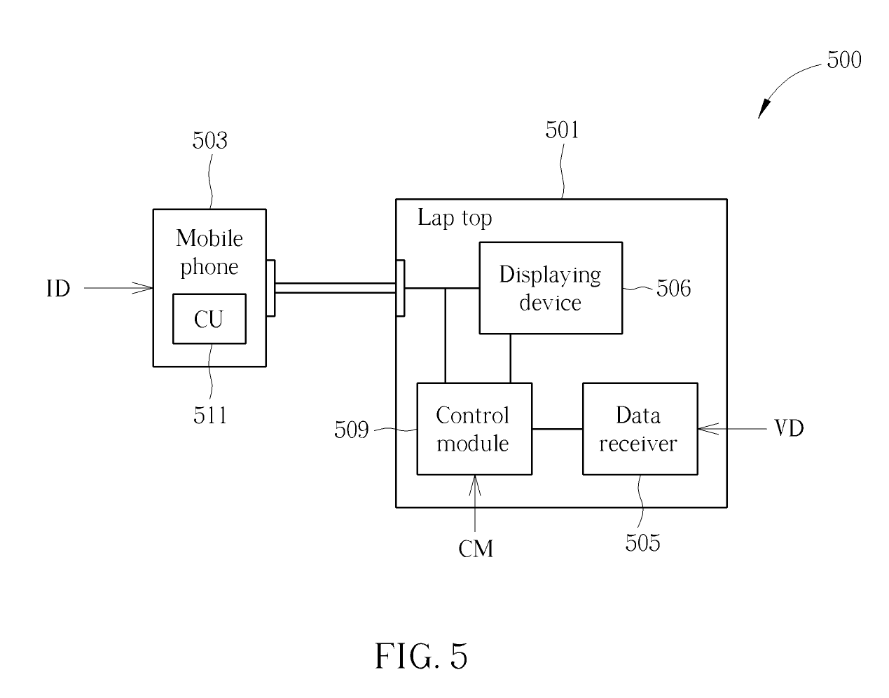

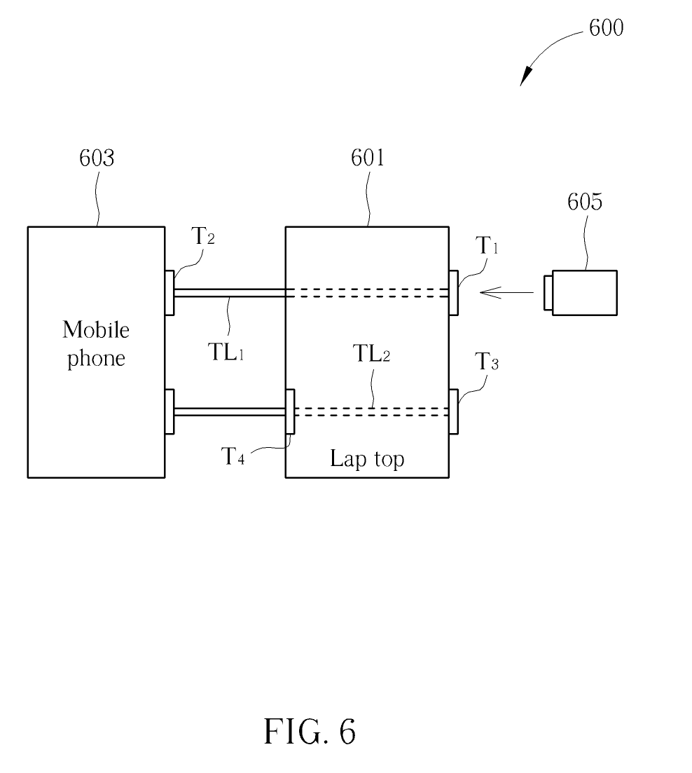

FIG. 5 and FIG. 6 are block diagrams illustrating the blocks for the mobile phone and the laptop according to different embodiments of the present application. Please note the above-mentioned operations are not limited to be performed by the video displaying system described in FIG. 5 and FIG. 6. Please refer FIG. 2/FIG. 5, or FIG. 2/FIG. 6 simultaneously to understand the present application for more clear. As shown in FIG. 5, a video displaying system 500 comprises a lap top 501 (i.e. 201 in FIG. 2) and a mobile phone 503 (i.e. 203 in FIG. 2). The lap top 501 comprises a data receiver 505, a displaying device 506 (i.e. 205 in FIG. 2), a connecting interface 507 and a control module 509. The data receiver 505 receives video data VD. As described above, the video data VD can be from any source. In one embodiment, the video data VD is from TV data and the data receiver 505 is a DTV (digital television) receiver. The displaying device 506 displays the video data VD. The control module 509 controls the data receiver 505, and the connecting interface 507.

The mobile phone 503 receives relative information ID related with the video data VD and transmits the relative information ID to the lap top 501 if the mobile phone 503 is connected to the lap top 501 via the connecting interface 507. The displaying device 506 also displays the relative information ID while displaying the video data VD, as shown in FIG. 2.

In one embodiment, the mobile phone 503 comprises a control unit 511 to control the displaying device 506 of the lap top 501 to display the video data and the relative information. In such case, the control module 509 only controls the data receiver 505 and the connecting interface 507. Also, the control module 509 can control the input interface such as 207 in FIG. 2, such that the user can provide control command CM to the control module 509 to vary data in the mobile phone 503. By this way, the control module 509 only needs to perform few functions such that a less powerful control unit can be applied for the control module 509. Additionally, the laptop 501 can comprise no storage device if the video data is from outside. Thereby the lap top 501 needs fewer and less powerful devices than a conventional laptop, such that the cost and weight for the lap top 501 can be reduced.

In the embodiment of FIG. 6, the video displaying system 600 also comprises a lap top 601 and a mobile phone 603. The lap top 601 can further comprise a transmitting interface, which can be a first type (first terminal T₁, transmitting path TL₁ and a second terminal T₂) or a second type (first terminal T₃, transmitting path TL₂ and a second terminal T₄). For the first type, the first terminal T₁ and the transmitting path TL₁ are disposed in the lap top 601, and the second terminal T₂ is coupled to the mobile phone 603. Therefore, the transmitting interface for the first type is independent from the connecting interface (ex, 507 in FIG. 5). For the second type, the first terminal T₃ and the transmitting path TL₂ are disposed in the lap top 601 as well, but the second terminal T₄ is integrated to the connecting interface. For both the first type and the second type, an external electronic device 605 such as a flash drive can connect to the first terminal to communicate with the mobile phone 603.

As described above, the mobile phone and the laptop can be replaced with other electronic devices. Therefore, a video data displaying system according to the present application can be summarized as follows: a video data displaying system, comprising a first electronic device (ex. lap top) and a second electronic device (ex. mobile phone). The first electronic device comprises: a data receiver, for receiving video data; a first displaying device, for displaying the video data; and a connecting interface. The second electronic device receives relative information related with the video data and transmitting the relative information to the first electronic device if the second electronic device is connected to the first electronic device via the connecting interface. The first displaying device also displays the relative information while displaying the video data. In one embodiment, the second electronic comprises a second displaying device smaller than the first displaying device.

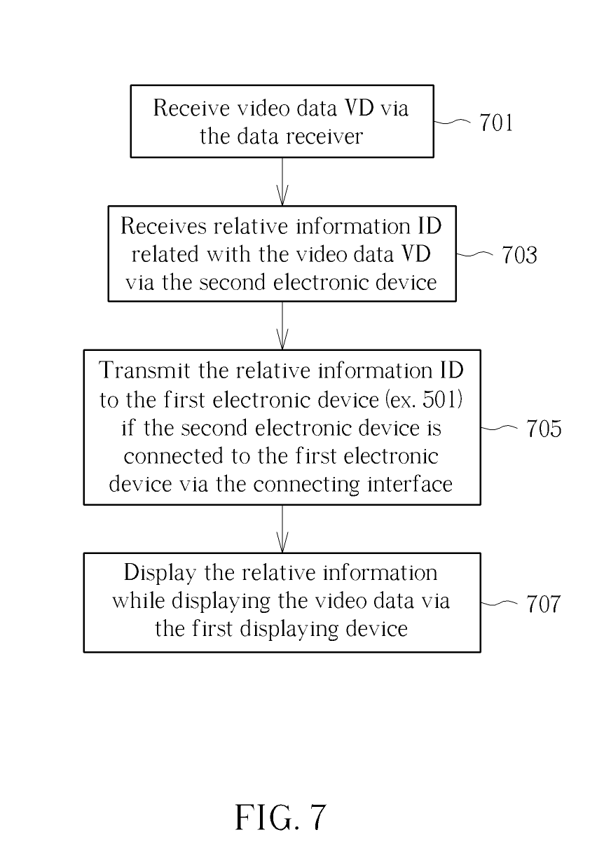

In view of above-mentioned embodiments, a video data displaying method can be acquired, which comprises the following steps shown in FIG. 7.

Step 701

Receive video data VD via the data receiver (ex. 505).

Step 703

Receives relative information ID related with the video data VD via the second electronic device (ex. 503).

Step 705

Transmit the relative information ID to the first electronic device (ex. 501)if the second electronic device is connected to the first electronic device via the connecting interface.

Step 707

Display the relative information while displaying the video data via the first displaying device.

In view of above-mentioned embodiments, the present application can provide following advantage: video data can be displayed on a larger displaying device; the information displayed with the video data is relative with the video data such that the user can get information about the video data or trigger process about the video data; the electronic device for displaying the video data can comprise fewer or less powerful devices such that the weight and the cost thereof can be reduced.

Those skilled in the art will readily observe that numerous modifications and alterations of the device and method may be made while retaining the teachings of the invention. Accordingly, the above disclosure should be construed as limited only by the metes and bounds of the appended claims.

1. A video data displaying system, comprising:
a first electronic device, comprising:
a data receiver, for receiving video data;
a first displaying device, for displaying the video data; and
a connecting interface;
a second electronic device, for receiving relative information related with the video data and transmitting the relative information to the first electronic device if the second electronic device is connected to the first electronic device via the connecting interface, wherein the first displaying device displays the relative information while displaying the video data.

2. The video data displaying system of claim 1, wherein the relative information comprises a link or a command related with the video data, where the first displaying device displays the link or the command while displaying the video data, wherein the first electronic device further comprises an input interface for receiving a control command to activate the link or the command.

3. The video data displaying system of claim 2, wherein the second electronic device further comprises a control unit to control the first displaying device to display the video data and the relative information, where the first electronic device comprises a control module arranged to only control the data receiver and the connecting interface.

4. The video data displaying system of claim 1, wherein the second electronic device further comprises a control unit to control the first displaying device to display the video data and the relative information, where the first electronic device comprises a control module arranged to only control the data receiver and the connecting interface.

5. The video data displaying system of claim 1, further comprising:
a transmitting interface, comprising a first terminal disposed in the first electronic device, a second terminal connected to the second electronic device;
wherein an external electronic device connects to the first terminal to communicate with the second electronic apparatus.

6. The video data displaying system of claim 5, wherein the second terminal is integrated with the connecting interface.

7. The video data displaying system of claim 6, wherein the second electronic device further comprises a control unit to control the first displaying device to display the video data and the relative information, where the first electronic device comprises a control module arranged to only control the data receiver and the connecting interface.

8. The video data displaying system of claim 6, wherein the second electronic device displays a first scene if the second electronic device is not connected to the first electronic device and displays a second scene if the second electronic device is connected to the first electronic device, where the first electronic device further comprises an input interface for receiving a control command, wherein the control command changes data corresponding to the second scene but does not change data corresponding to the first scene.

9. The video data displaying system of claim 5, wherein the second electronic device displays a first scene if the second electronic device is not connected to the first electronic device and displays a second scene if the second electronic device is connected to the first electronic device, where the first electronic device further comprises an input interface for receiving a control command, wherein the control command changes data corresponding to the second scene but does not change data corresponding to the first scene.

10. The video data displaying system of claim 5, wherein the second electronic device further comprises a control unit to control the first displaying device to display the video data and the relative information, where the first electronic device comprises a control module arranged to only control the data receiver and the connecting interface.

11. The video data displaying system of claim 10, wherein the second electronic device displays a first scene if the second electronic device is not connected to the first electronic device and displays a second scene if the second electronic device is connected to the first electronic device, where the first electronic device further comprises an input interface for receiving a control command, wherein the control command changes data corresponding to the second scene but does not change data corresponding to the first scene.

12. The video data displaying system of claim 1, wherein the second electronic device displays a first scene if the second electronic device is not connected to the first electronic device and displays a second scene if the second electronic device is connected to the first electronic device, where the first electronic device further comprises an input interface for receiving a control command, wherein the control command changes data corresponding to the second scene but does not change data corresponding to the first scene.

13. A video data displaying method, applied to a video data displaying system comprising a first electronic device and a second electronic device, wherein the first electronic device comprises a first displaying device, a data receiver and a connecting interface, wherein the video data displaying method comprises:
receiving video data via the data receiver;
receiving relative information related with the video data via the second electronic device;
transmitting the relative information to the first electronic device if the second electronic device is connected to the first electronic device via the connecting interface; and
displaying the relative information while displaying the video data via the first displaying device.

14. The video data displaying method of claim 13, wherein the relative information comprises a link or a command related with the video data, where the first displaying device displays the link or the command while displaying the video data, wherein the first electronic device further comprises an input interface for receiving a control command to activate the link or the command.

15. The video data displaying method of claim 14, wherein the second electronic device further comprises a control unit to control the first displaying device to display the video data and the relative information, where the first electronic device comprises a control module arranged to only control the data receiver and the connecting interface.

16. The video data displaying method of claim 13, wherein the second electronic device further comprises a control unit to control the first displaying device to display the video data and the relative information, where the first electronic device comprises a control module arranged to only control the data receiver and the connecting interface.

17. The video data displaying method of claim 13, wherein the first electronic device further comprises an input interface, wherein the video data displaying method further comprises:
displaying a first scene via the second electronic device if the second electronic device is not connected to the first electronic device;
displaying a second scene via the second electronic device if the second electronic device is connected to the first electronic device;
receiving a control command from the input interface; and
changing data corresponding to the second scene according to the control command but does not changing data corresponding to the first scene according to the control command.

18. The video data displaying method of claim 17, wherein the second electronic device further comprises a control unit to control the first displaying device to display the video data and the relative information, where the first electronic device comprises a control module arranged to only control the data receiver and the connecting interface.

19. The video data displaying method of claim 18, wherein the relative information comprises a link or a command related with the video data, where the first displaying device displays the link or the command while displaying the video data, wherein the first electronic device further comprises an input interface for receiving a control command to activate the link or the command.

20. The video data displaying method of claim 17, wherein the relative information comprises a link or a command related with the video data, where the first displaying device displays the link or the command while displaying the video data, wherein the first electronic device further comprises an input interface for receiving a control command to activate the link or the command.

21. The video data displaying system of claim 1, wherein the relative information changes corresponding to content of the video data.

22. The video data displaying system of claim 1, wherein the video data is from a source which is not the second electronic device.

23. The video data displaying method of claim 13, wherein the relative information changes corresponding to content of the video data.

24. The video data displaying method of claim 13, wherein the video data is from a source which is not the second electronic device.
